(19) United States
(12) Patent Application Publication
(10) Pub. No.: US 2020/0011094 A1
(43) Pub. Date: Jan. 9, 2020

(54) VEHICLE DOOR LATCH

(71) Applicant: Inteva Products, LLC, Troy, MI (US)

(72) Inventors: Francisco Javier Guevara Arreola, Cd. Juarez (MX); Carlos Issac Tostado Bocanegra, Cd. Juarez (MX); Oscar Omar Estrada Lazcano, Cd. Juarez (MX); Ari Yussel Mino Ramirez, Cd. Juarez (MX); Victor Daniel Varela Antillon, Cd. Juarez (MX); Jesus Osvaldo Alvarez Morales, Cd. Juarez (MX)

(21) Appl. No.: 16/026,727

(22) Filed: Jul. 3, 2018

(51) Int. Cl. E05B 77/34; E05B 77/36; E05B 15/16; E05B 77/26; E05B 85/02

(52) U.S. Cl. CPC E05B 77/34; E05B 77/36; E05B 85/02; E05B 77/26; E05B 15/1635

(57) ABSTRACT

A vehicle latch assembly includes a plurality of levers for transferring actuation forces to open and close the vehicle latch assembly, at least one of the plurality of levers formed of at least one polymer, wherein the plurality of levers includes a child lock engage lever. Also included is an actuator housing assembly including a water deflector enclosing a connection between an actuator housing and a cover, the vehicle latch assembly reducing sound, reducing release effort, and reducing water intrusion.

### BACKGROUND

The subject matter disclosed herein relates to vehicle door latches.

Vehicle door latches must meet strength and sound requirements for various markets. The release feeling of some latches is not smooth and a user experiences undesired “bumps” during operating. Additionally, a high seal load release requirement may not be met by prior assemblies. Child security lock and unlock efforts are not precise and they decrease after high temperature exposure in some latch assemblies. Latches also must address the possibility of water intrusion. Therefore, proper sealing and/or diversion of water away from interior portions of the latch assembly must be provided.

### SUMMARY

Disclosed is a vehicle latch assembly. The assembly includes a plurality of levers for transferring actuation forces to open and close the vehicle latch assembly, at least one of the plurality of levers formed of at least one polymer, wherein the plurality of levers includes a child lock engage lever. Also included is an actuator housing assembly including a water deflector enclosing a connection between an actuator housing and a cover, the vehicle latch assembly reducing sound, reducing release effort, and reducing water intrusion.

Also disclosed is a vehicle latch assembly. The assembly includes a plurality of levers for transferring actuation forces to open and close the vehicle latch assembly, at least one of the plurality of levers formed of at least one polymer, at least one of the plurality of levers include at least one reinforcement rib. The assembly also includes an actuator housing assembly including a water deflector enclosing a connection between an actuator housing and a cover. The assembly further includes a child security mechanism having a torsion spring connecting the child security mechanism to an inner release mechanism.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawing in which:

FIG. 1 is a first perspective view of a housing of a vehicle latch assembly;

FIG. 2 is a second perspective view of the housing;

FIG. 3 is an elevational view of a claw and pawl of the vehicle latch assembly;

FIG. 4 is a perspective view of the vehicle latch assembly;

FIG. 5 is an elevational view of the vehicle latch assembly;

FIG. 6 is a perspective view of a child security mechanism of the vehicle latch assembly; and

FIG. 7 is an elevational view of the child security mechanism.

The detailed description explains embodiments of the invention, together with advantages and features, by way of example with reference to the drawing.

### DETAILED DESCRIPTION OF THE INVENTION

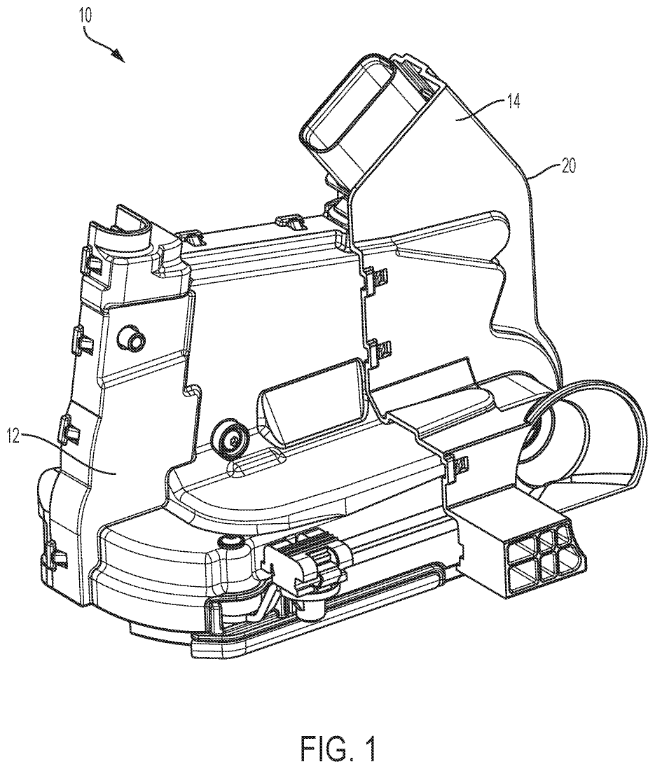

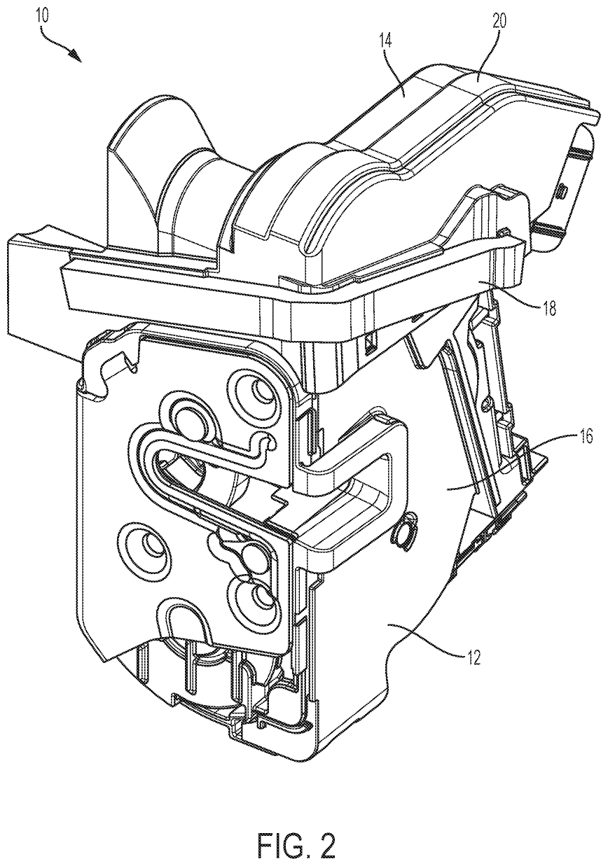

Referring to FIGS. 1 and 2, reference numeral 10 generally designates a vehicle latch assembly according to a first embodiment. The vehicle latch assembly 10 is generally designed for use on a vehicle (not illustrated) having a vehicle door with a door handle. The vehicle latch assembly 10 may be installed on the driver side door or a passenger side door in some embodiments. Additionally, it is contemplated that the vehicle latch assembly 10 may be installed in alternative locations of the vehicle, such as a vehicle door opening on the B-pillar or may be used in conjunction with a rear door of the vehicle, such as a liftgate, trunk or tailgate, for example.

The vehicle latch assembly 10 includes a housing 12 that helps protect the vehicle latch assembly 10 from damage, as well as dirt and debris. The housing 12 is mounted to the vehicle door, such as with a plurality of mechanical fasteners or welding, for example. The housing 12 includes a water deflector 14 that encloses the connection between an actuator housing 16 and a cover 18, thereby eliminating potential moisture intrusion areas. The water deflector 14 includes one or more bends 20 to deflect moisture. A seal foam 22 is provided to maintain a constant foam compression with door sheet metal, thereby guiding moisture away from the latch interior components. The water deflector prevents water intrusion to interior regions of the vehicle latch assembly 10, which is a concern with latch assemblies, as described above.

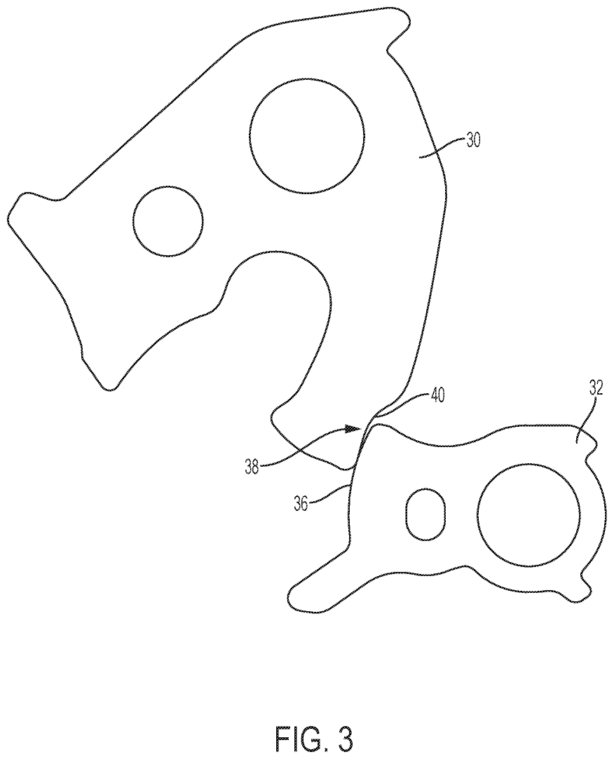

FIG. 3 shows interior components of the vehicle latch assembly 10. A rotatable claw 30 releasably retains a striker (not shown) to hold the door (or liftgate, trunk, tailgate, etc.) in a closed position. The claw 30 is held in the closed position by a pawl 32. The pawl 32 is actuated to disengage from the claw 30, thereby allowing the claw 30 to be released and biased toward an open position. This operation releases the striker from the claw 30 and facilitates an opening of the vehicle door. The pawl 32 is at least partially disposed within the housing 12. The pawl 32 is pivotable about an axis and rotatable between different operating positions. During various rotational positions of the pawl 32 and claw 30, the claw and pawl come into close proximity with each other, such that contact occurs. Such contact may generate an audible sound which is likely to be unpleasant to a user.

To reduce the undesirable sound attributed to claw 30 and pawl 32 contact, a pawl radius of curvature 34 at a pawl contact surface region 36 is matched to a claw radius of curvature 38 at a claw contact surface region 40. The radii of curvature may vary depending upon the application. This improves the closing and opening sound of the overall latch assembly.

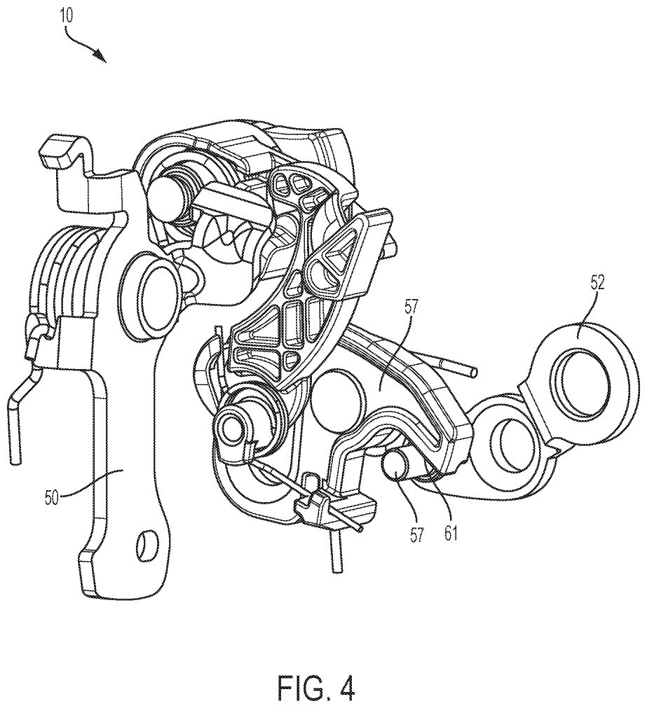

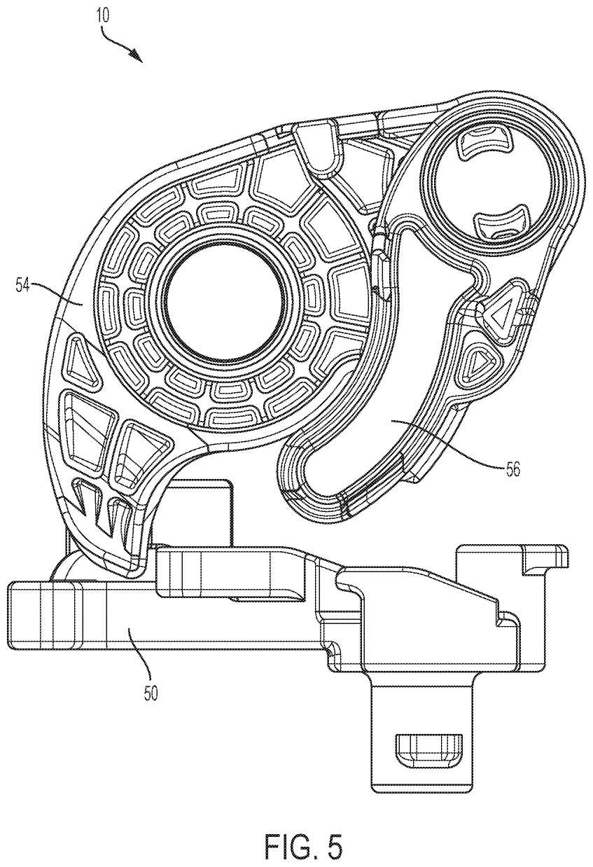

Referring now to FIGS. 4 and 5, the housing 12 of the latch assembly 10 is removed to illustrate other interior components of the latch assembly 10. Several components of the latch assembly 10 are formed of at least one polymer. In some embodiments, an intermittent lever 50 (FIG. 4), an outer release lever 52 (FIG. 4), an inner release lever 54 (FIG. 5), and a child lock engage lever 56 (FIG. 5) are formed as injection molded polymer parts. By forming these components of a polymer, rather than steel as traditionally done, more specific geometries are attainable and release travel accuracy are improved. Some or all of the levers include at least one rib to structurally reinforce the components.

FIG. 4 also illustrates a lever 57 configured for contact with a bolt 59. The interface surface 61 of the lever 57 includes a curved surface. The entire lever 57 or only the interface surface 61 is formed of a polymer to improve sound quality.

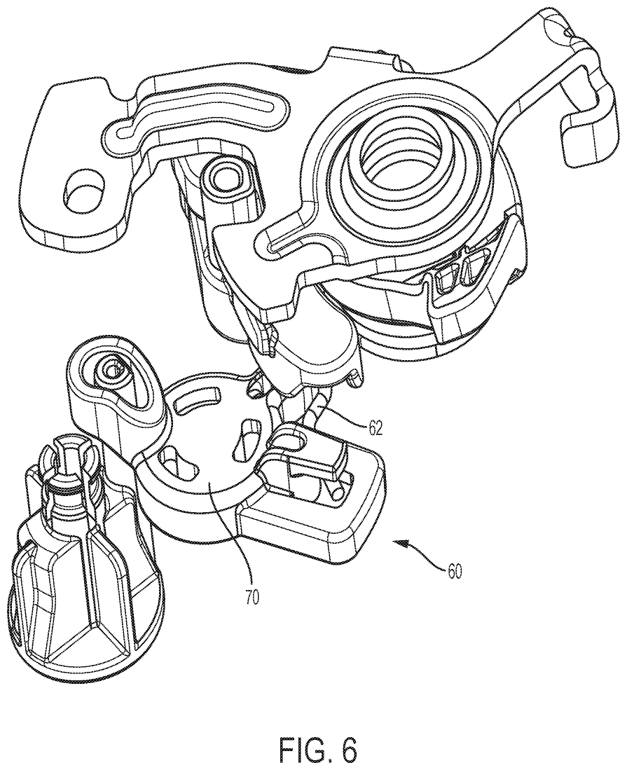

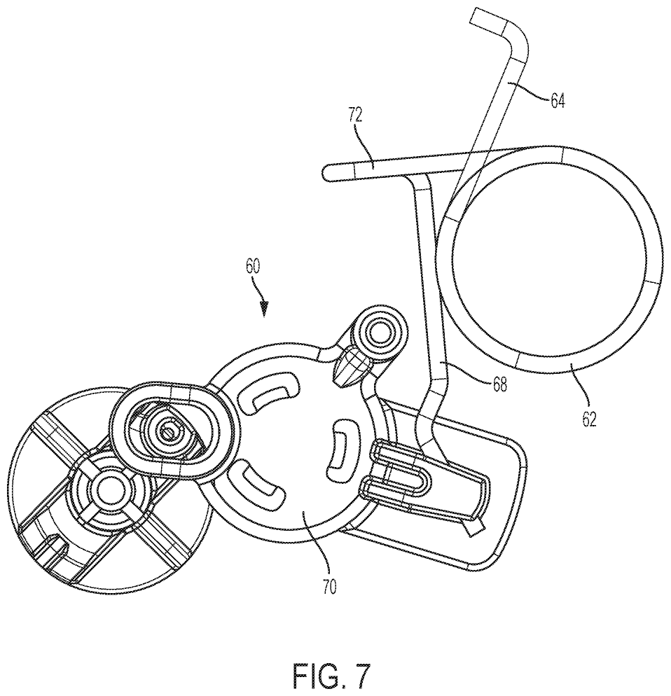

Referring to FIGS. 6 and 7, a child security mechanism 60 of the latch assembly 10 is illustrated. The child security mechanism 60 includes a steel torsional spring 62 that provides precise and accurate lock and unlock efforts even after thermal exposure. The spring 62 is a common spring between two mechanisms, specifically an inner release mechanism and the child security mechanism 60. One of the spring legs 64 interacts with the inner release lever 54, providing a required effort on the inner release lever 54 and the other leg 68 interacts on the child security actuator lever 70 as a cantilever bar with a bump 72. The bump 72 on the spring leg accommodates the child lock mechanism 60 in either a locked or unlocked position.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle latch assembly comprising:
a plurality of levers for transferring actuation forces to open and close the vehicle latch assembly, at least one of the plurality of levers formed of at least one polymer, wherein the plurality of levers includes a child lock engage lever; and
an actuator housing assembly including a water deflector enclosing a connection between an actuator housing and a cover, the vehicle latch assembly reducing sound, reducing release effort, and reducing water intrusion.

2. The vehicle latch assembly of claim 1, wherein at least one of the plurality of levers include at least one reinforcement rib.

3. The vehicle latch assembly of claim 1, wherein the plurality of levers includes an intermittent lever.

4. The vehicle latch assembly of claim 1, wherein the plurality of levers includes an outer release lever.

5. The vehicle latch assembly of claim 1, wherein the plurality of levers includes an inner release lever.

6. The vehicle latch assembly of claim 1, wherein at least one of the plurality of levers includes a curved interface surface for contacting a bolt, the curved interface surface formed of a polymer.

7. The vehicle latch assembly of claim 1, wherein the water deflector includes at least one bend.

8. The vehicle latch assembly of claim 1, further comprising a child security mechanism having a torsion spring connecting the child security mechanism to an inner release mechanism.

9. The vehicle latch assembly of claim 8, wherein the torsion spring includes a spring leg having a bump.

10. A vehicle latch assembly comprising:
a plurality of levers for transferring actuation forces to open and close the vehicle latch assembly, at least one of the plurality of levers formed of at least one polymer, at least one of the plurality of levers include at least one reinforcement rib;
an actuator housing assembly including a water deflector enclosing a connection between an actuator housing and a cover; and
a child security mechanism having a torsion spring connecting the child security mechanism to an inner release mechanism.

11. The vehicle latch assembly of claim 10, wherein the water deflector includes at least one bend.

12. The vehicle latch assembly of claim 10, wherein the torsion spring includes a spring leg having a bump.

13. The vehicle latch assembly of claim 10, wherein the plurality of levers includes at least one of an intermittent lever, an outer release lever, an inner release lever, and a child lock engage lever.

14. The vehicle latch assembly of claim 13, wherein at least one of the plurality of levers includes a curved interface surface for contacting a bolt, the curved interface surface formed of a polymer.
